(19) United States
(12) Patent Application Publication
(10) Pub. No.: US 2026/0067428 A1
(43) Pub. Date: Mar. 5, 2026

(54) System

(71) Applicant: Softbank Group Corp., Tokyo (JP)

(72) Inventor: Masaki Hamada, Tokyo (JP)

(21) Appl. No.: 19/317,453

(22) Filed: Sep. 3, 2025

(30) Foreign Application Priority Data
Sep. 4, 2024 (JP) 2024-152628

(51) Int. Cl. H04N 7/18; A01K 27/00; G06V 20/52

(52) U.S. Cl. CPC H04N 7/185; A01K 27/001; A01K 27/009; G06V 20/52

(57) ABSTRACT

A system includes a processor that controls a waterproof device equipped with a camera, a microphone, and various sensors, said device being attachable to a collar, wherein the processor analyzes in real time information collected from the camera and the microphone by means of an AI infrastructure implemented on a server, and wherein the processor transmits instructions generated by the server to a speaker for communicating the instructions to a rescue dog.

### CROSS-REFERENCE TO RELATED APPLICATION

This application is based on and claims priority under 35 USC 119 from Japanese Patent Application No. 2024-152628 filed on Sep. 4, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In disaster sites, rescue operations using rescue dogs are hampered by the inability to accurately grasp the dog's perspective and environmental conditions in real time. Handlers and support members often face challenges in communicating effective instructions to the rescue dog, particularly under harsh or noisy conditions where visibility and audibility are limited. Furthermore, it is difficult to quickly identify the presence of victims or hazards based solely on the dog's behavior without reliable means of remote monitoring and direct feedback.

### SUMMARY

To solve these problems, the present invention provides a system comprising a waterproof device equipped with a camera, a microphone, and various sensors that is attachable to the dog's collar, a processor that analyzes in real time the information collected from the camera and microphone using an AI infrastructure implemented on a server, and a speaker to communicate instructions generated by the server to the rescue dog. The system also enables a remote handler to view real-time information and issue instructions, and allows the AI infrastructure to perform object recognition analysis on images captured by the camera in order to detect specific targets.

“Processor” means a computing apparatus or device capable of processing data, executing instructions, and controlling operation of the various components of the system.

“Waterproof device” means the hardware unit is constructed to resist the ingress of water, allowing operation in wet or harsh environmental conditions.

“Camera” means an optical sensor capable of capturing still images or moving video, providing a visual record of the environment from the perspective of the rescue dog.

“Microphone” means an acoustic sensor capable of capturing audio signals, including ambient environmental sounds and human voices.

“Sensor” means an electronic component capable of detecting and measuring physical parameters, such as temperature, humidity, or acceleration.

“Collar” means a strap or band designed to be worn around the neck of a rescue dog, serving as a mounting point for the waterproof device.

“AI infrastructure” means a set of hardware and software resources implemented on a server, which provide artificial intelligence functions such as data analysis, pattern recognition, and decision-making.

“Server” means a computer or networked computing system that processes data sent from the waterproof device, performs AI-based analysis, and generates action instructions.

“Speaker” means an audio output component which delivers voice or sound instructions from the system to the rescue dog.

“Handler” means a person responsible for managing, directing, and giving instructions to the rescue dog, potentially from a remote location.

“Object recognition” means an automated analysis process whereby the AI infrastructure detects and identifies specific objects or targets in images captured by the camera.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

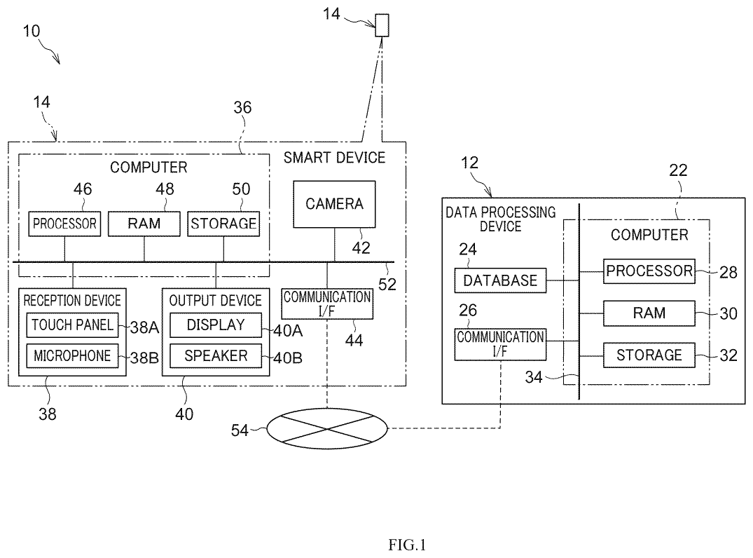

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

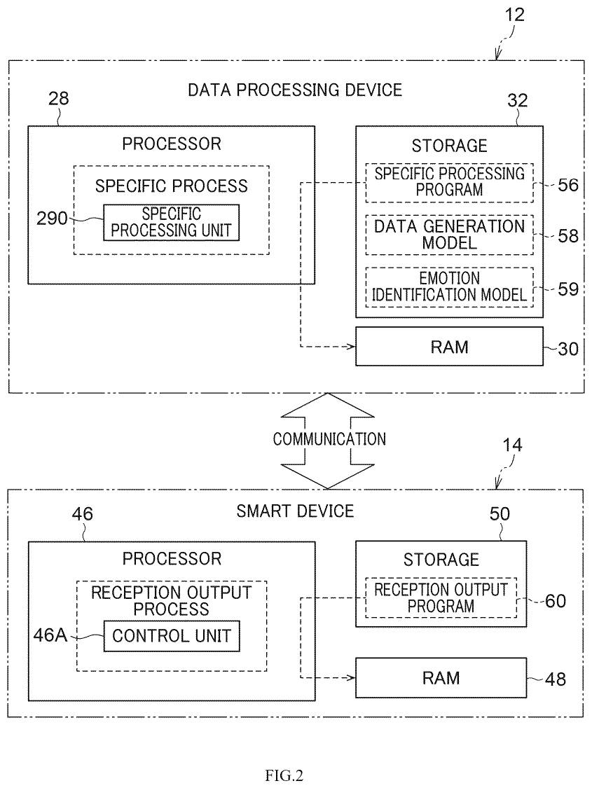

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In disaster rescue operations utilizing animals fitted with information collection devices, it has been challenging to collect, analyze, and respond to environmental and situational data in real time. Conventional systems generally require manual analysis or lack the ability to provide timely and accurate behavioral instructions to the rescue animal based on complex, multi-modal data. Additionally, remotely located operators face difficulty in understanding the situational context and issuing precise commands, resulting in reduced efficiency and success rates in rescue missions.

The specific processing by the specific processing unit 290 of the data processing device 12 in Example 1 is realized by the following means.

The present invention provides a server comprising a processor configured to receive video, audio, and environmental data from a waterproof information collection device mounted on an animal, to analyze the received data using image and audio recognition units, to generate behavior command data based on analysis results and user feedback by utilizing a generative artificial intelligence model, to convert the command data into audio data, and to output the data to an audio output device. This enables real-time, automated creation and delivery of context-appropriate behavioral instructions to the rescue animal, while also allowing a remote operator to monitor and control the animal's actions efficiently through an interactive user interface.

The term “information collection device” refers to a device comprising an imaging device, an audio input device, and an environmental information detection device, all incorporated within a waterproof structure and mounted on an animal-retaining apparatus, for the purpose of collecting video, audio, and environmental data.

The term “imaging device” refers to an apparatus capable of capturing visual information from the surroundings of the animal, such as a camera, and providing video data to the processor.

The term “audio input device” refers to an apparatus, such as a microphone, that captures ambient sounds, including environmental noises and vocal signals, and outputs audio data to the processor.

The term “environmental information detection device” refers to a sensor or a plurality of sensors capable of measuring environmental conditions, such as temperature, humidity, and acceleration, in the animal's vicinity.

The term “animal-retaining apparatus” refers to an apparatus such as a collar or harness that allows the information collection device to be securely mounted on the animal. The term “processor” refers to a hardware or software computational unit configured to execute data processing tasks such as receiving, analyzing, and interpreting information, as well as generating and transmitting behavior command data.

The term “wireless communication” refers to data transmission technology that allows the information collection device and the server to exchange data without the use of physical cables, typically through radio signals such as Wi-Fi or mobile networks. The term “image recognition processing unit” refers to hardware or software capable of analyzing image data using image analysis algorithms to identify and detect objects or persons of interest from received video information.

The term “audio recognition processing unit” refers to hardware or software capable of analyzing audio data using audio analysis or speech recognition algorithms to detect specific sounds, words, or patterns from the received audio information.

The term “artificial intelligence model including a generative method” refers to a computational model, such as a neural network, capable of producing new data or instructions based on learned patterns from multi-modal input, including the ability to generate behavior command data in response to a prompt sentence containing recognized objects or audio.

The term “behavior command data” refers to data representing specific actions or instructions intended to direct the behavior of the animal in response to the recognized situational context.

The term “speech conversion processing unit” refers to a unit that transforms text-based behavior command data into audio data, for example using a text-to-speech algorithm or service.

The term “audio output device” refers to a device, such as a speaker, that outputs audio data so that it can be perceived by the animal.

The term “remote operation terminal” refers to a computing device, such as a smartphone or tablet, used by an operator at a location remote from the animal to monitor information, input commands, and interact with the system.

The term “user interface” refers to software or hardware elements displayed or provided on the remote operation terminal for visualizing information obtained or generated by the processor and for accepting user operation input.

An embodiment for implementing the present invention is described below with reference to the structure and operation of the claimed system.

The system comprises an information collection device, a processor (server), audio output device, and a remote operation terminal equipped with a user interface. The information collection device is constructed by integrating an imaging device (such as a high-resolution camera suitable for day and night operation), an audio input device (such as a microphone), and an environmental information detection device (such as temperature, humidity, and acceleration sensors) within a waterproof housing. This device is securely mounted on an animal using an animal-retaining apparatus such as a collar or harness.

The information collection device is configured to collect real-time video, audio, and environmental data as the animal moves in the operational field. Video information is captured by the camera, ambient sound and vocal signals are captured by the microphone, and environmental information—such as temperature, humidity, and motion—is gathered by the respective sensors. This data is temporarily stored and then transmitted wirelessly to the processor via Wi-Fi or LTE mobile network communication.

The processor may be a server computer or equivalent computational unit equipped with suitable storage and processing capabilities. Upon receiving the data stream from the information collection device, the processor applies image recognition processing using software such as TensorFlow and OpenCV to analyze the video. The processor runs audio recognition processing, for example, via open-source speech recognition tools or commercially available speech-to-text APIs, to detect particular acoustic features or spoken commands from the audio stream.

Based on the combined analysis from image and audio recognition, together with environmental sensor input, the processor provides a prompt sentence as input to a generative artificial intelligence model. The generative AI model, implemented using machine learning frameworks such as PyTorch or TensorFlow, receives the prompt and generates appropriate behavior command data for the animal. For converting the generated instruction into an audio output, the processor uses a speech conversion processing unit, such as a text-to-speech engine or API, to synthesize audio data.

The resulting audio data is transmitted to the audio output device, such as a waterproof speaker that is part of the information collection device. The speaker outputs the command so that the animal can receive guidance in real time.

The remote operation terminal, such as a smartphone or tablet, is equipped with a user interface application that displays live or recent information including video footage, audio events, sensor data, and the location of the animal. The user at the remote site can observe the current situation, input additional instructions via the application, and send these instructions to the processor. The processor then incorporates user instructions into the input for the generative AI model, ensuring that both automatic and operator-driven commands can be generated.

As a specific example, when operating in a disaster scenario, the animal may be searching through rubble. The information collection device captures the scene and audio, and detects a particular human voice such as “Help.” The processor analyzes this input, and, using the generative AI model, formulates the next action such as “Move right and wait for additional sounds.” This command is converted into speech and output to the animal through the speaker.

A typical prompt sentence used as input to the generative AI model might be:

“A rescue dog at a disaster site has detected a person's image in front and picked up the sound ‘Help!’ from the microphone. Please generate the next command for the dog.”

By integrating these hardware and software components and coordinating their functions as described, the present invention enables an efficient, real-time rescue support system where both automated AI generation and human instructions are seamlessly relayed to a rescue animal to advance disaster response operations.

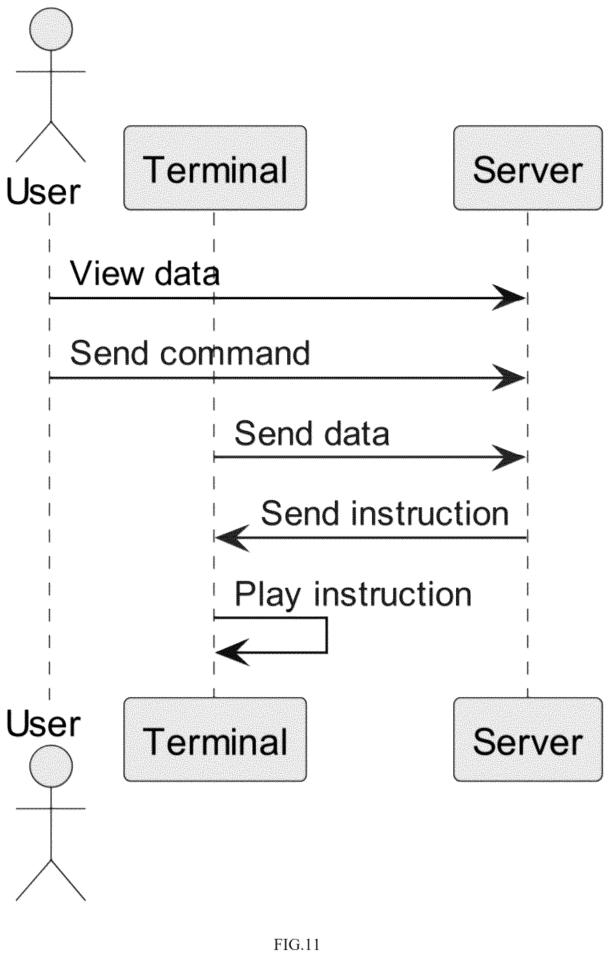

The following describes the processing flow using FIG. 11.

### Step 1:

Terminal collects real-time video, audio, and environmental sensor data from the surroundings using its integrated camera, microphone, and environmental sensors. The input for this step is the physical environment around the animal. Terminal processes the raw data by digitizing the video frames, encoding the audio signal, and sampling sensor values, then temporarily stores this data in an internal buffer. The output is a structured data packet containing video, audio, and sensor data.

### Step 2:

Terminal establishes a wireless communication link (such as Wi-Fi or LTE) and transmits the buffered data packets to the server at regular intervals. The input is the structured data packet generated in Step 1. Terminal applies data compression techniques, such as H.264 for video and AAC for audio, to minimize bandwidth usage. The output is a stream of compressed data packets transmitted over the wireless network to the server.

### Step 3:

Server receives the incoming data packets from the terminal via the wireless network. The input is the stream of compressed data packets. Server decompresses the data, reconstructs the video frames and audio streams, and parses the sensor data. The output is a set of synchronized video frames, audio signals, and time-stamped environmental sensor values available for analysis.

### Step 4:

Server analyzes the video data by applying an image recognition algorithm, for example, using a trained neural network model implemented with TensorFlow or OpenCV. The input is the reconstructed video frames. Server performs object detection and scene analysis to identify humans, obstacles, or specific target objects. The output is a list of detected objects, their positions within the frame, and their confidence levels.

### Step 5:

Server analyzes the audio data using a speech recognition algorithm or audio event detection model. The input is the reconstructed audio stream. Server detects keywords, such as calls for help, or identifies specific environmental sounds. The output is a list of detected sounds or transcribed speech, along with their timestamps and confidence scores.

### Step 6:

Server aggregates the results from image and audio analysis, combines them with sensor readings, and prepares a prompt sentence as input to a generative AI model. The input is the list of detected objects, sounds, and current sensor values. Server formulates the contextual scene into a textual prompt, such as “A person is detected in the video. The sound ‘Help!’ is detected. Temperature is 25° C.” Server inputs this prompt into the generative AI model, which processes the prompt and generates appropriate behavioral command data. The output is a text command for the animal, such as “Move right” or “Stay.”

### Step 7:

Server converts the generated text command into an audio instruction using a text-to-speech engine. The input is the behavioral command text from Step 6. Server applies natural language processing and speech synthesis techniques, producing an audio file in a format such as MP3 or WAV. The output is a digital audio file containing the spoken instruction.

### Step 8:

Server transmits the synthesized audio instruction to the terminal over the wireless network. The input is the audio file generated in Step 7. Terminal receives the file and checks for data integrity. The output is the audio instruction ready for playback on the terminal.

### Step 9:

Terminal plays back the received audio instruction through its waterproof speaker at an appropriate volume for the animal to hear. The input is the received audio instruction. Terminal controls the speaker hardware to ensure real-time playback and adjusts volume based on environmental noise levels if necessary. The output is the animal hearing the clear behavioral command.

### Step 10:

User accesses the server through a remote operation terminal, such as a smartphone or tablet, and monitors live video, audio, and sensor information displayed on the user interface. The input is the real-time situational data received from the server. User can review the animal's route on a map, current sensory inputs, and detected events. The output is an updated display for the user and, if necessary, user-generated manual instructions entered via the interface.

### Step 11:

Server receives any user-generated instruction from the remote operation terminal. The input is the manual instruction text from the user. Server processes and, if necessary, converts the manual instruction into a prompt sentence for the generative AI model, following Steps 6 and 7. The output is a new behavioral command sent to the terminal to guide the animal according to the user's guidance.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In disaster rescue scenarios, there are significant challenges in efficiently collecting, analyzing, and utilizing environmental, visual, and audio information from rescue animals or robots in the field. Conventional systems often lack real-time, adaptive, and context-aware data analysis capabilities. Moreover, current approaches fail to leverage advanced artificial intelligence, such as generative AI models, for dynamic action instruction generation based on complex and diverse sensor inputs. Additionally, there exists a need to account for the emotional state of the human operator to further optimize operational effectiveness and safety.

The specific processing by the specific processing unit 290 of the data processing device 12 in Application Example 1 is realized by the following means.

The present invention provides a server comprising a processor configured to acquire image, audio, and environmental information via an animal-mounted or robot-mounted information acquisition unit, transmit such information to an external device via wireless communication, process the received data using dedicated image, audio, and environmental analysis functions, automatically generate a prompt sentence and input it to a generative artificial intelligence model, generate action instructions using said model, output the instructions to a terminal in audio form, and continuously acquire and analyze feedback from post-action data. The processor is additionally configured to allow real-time user monitoring and remote operation, and to analyze the emotional state of the user based on input data, thereby adaptively modifying prompt sentences and action instructions accordingly. This enables real-time, intelligent decision making, dynamic instruction adaptation, and robust disaster rescue operations that respond both to environmental changes and to user emotional context.

The term “processor” refers to an information processing unit or circuitry capable of executing programmed instructions to perform data acquisition, analysis, communication, and control functions within the system.

The term “information acquisition unit” refers to a device or module mounted on an animal, robot, or terminal that is equipped with sensors such as a camera, microphone, and environmental sensors for collecting image, audio, and environmental data.

The term “image information” refers to visual data obtained from an image-capturing device, such as a camera, which may include still images or video sequences of the surrounding environment.

The term “audio information” refers to data related to sound, including ambient noise, voice signals, or other acoustic phenomena, captured by a sound-collecting device.

The term “environmental information” refers to data pertaining to physical or environmental conditions, such as temperature, humidity, motion, or other sensor readings collected from the field.

The term “wireless communication” refers to the transmission and reception of data via radio waves or other wireless protocols between the information acquisition unit and the external device or server.

The term “external device” refers to a computing system located remotely from the terminal or acquisition unit, typically including a server with data storage and processing capabilities.

The term “image processing function” refers to a software or hardware component for analyzing image information, including but not limited to object detection, recognition, or segmentation.

The term “audio processing function” refers to a software or hardware component for analyzing audio information, including but not limited to speech recognition, sound event detection, or phrase extraction.

The term “environmental data processing function” refers to a software or hardware component for analyzing environmental information, such as anomaly detection, trend analysis, or threshold assessment of environmental parameters.

The term “prompt sentence” refers to a structured and context-specific textual input automatically generated from the analyzed sensor data, which is used to guide the generative artificial intelligence model in producing relevant output.

The term “generative artificial intelligence model” refers to a machine learning model designed to generate responses, instructions, or predictions based on input data, including models such as large language models or other advanced AI algorithms.

The term “action instruction” refers to a command or series of directives generated by the generative artificial intelligence model, instructing the terminal or animal to perform specific actions.

The term “terminal” refers to any end-point device, such as a robotic platform, vehicle, or an animal-mounted device, capable of receiving action instructions and executing corresponding operations.

The term “feedback process” refers to the procedure wherein data regarding the results or status following an executed action are reacquired by the information acquisition unit and subsequently sent for further analysis and instruction refinement.

The term “user” refers to an operator or handler who interacts with the system, monitors real-time data and instructions, and may provide manual inputs or commands for remote operation.

The term “emotional state” refers to a quantified or analyzed state of the user, determined from audio or image information, representing the user's psychological condition such as stress, anxiety, or calmness.

The term “remote operation instruction” refers to a command input by the user from a distant location via a terminal or display device, which is transmitted to and processed by the system for controlling or influencing terminal or system actions.

In an embodiment of the invention, the system comprises an information processing apparatus (server), one or more terminals (such as animal-mounted or robot-mounted devices), and a user interface for remote operation and monitoring. The following describes the detailed configuration, operation, and usage of the invention in accordance with the claims.

The terminal is equipped with a set of sensors forming an information acquisition unit. This unit typically includes a camera (for example, using a generic CMOS image sensor), a microphone (for ambient sound and voice acquisition), and one or more environmental sensors, such as temperature, humidity, and acceleration sensors. All of these components are housed within a wearable waterproof device, such as a collar for an animal or a housing for a robot, making the system robust for use in harsh environments.

The terminal further includes a wireless communication module (such as a 4G/5G modem, Wi-Fi, or Bluetooth transceiver), a memory for temporary data storage, an audio output unit (speaker), and an onboard controller that handles sensor operation, data packetization, and communication protocols. The terminal continually or periodically collects image, audio, and environmental data from the field. Sensor data are encoded, time-stamped, and prepared for transmission.

The server is a general computation device (for instance, a cloud server or a dedicated computer) equipped with reliable storage, data processing capability, and network interfaces. The server may use hardware such as CPUs and GPUs, and can be implemented on general-purpose computing resources. The server receives data sent from one or more terminals. On arrival, the server manages the data with an organized storage system, such as a database structure or file storage.

For image data, the server utilizes image processing functions with software frameworks such as OpenCV or TensorFlow. These functions are capable of performing object recognition, detection of persons, debris, obstacles, and relevant features as might be necessary in a disaster environment. For audio data, the server applies audio processing functions, which may be based on open-source speech recognition libraries or cloud-based services. These functions include speech-to-text conversion, keyword spotting, and possibly identification of emotional cues from the audio stream. Environmental sensor data, such as temperature or motion, are analyzed through dedicated routines implemented as Python programs, which are capable of identifying anomalies or trends (for instance, sudden temperature increases or abrupt movements).

After conducting the analyses, the server automatically generates a prompt sentence. This prompt sentence describes the current situation or data findings and serves as the input to a generative AI model (e.g., a large language model implemented with libraries such as PyTorch or TensorFlow). The generative AI model runs on the server's processor, optionally using hardware accelerators (such as GPUs), and produces contextually appropriate action instructions. These instructions can then be further tailored, if necessary, according to the emotional state of the operator, which may be deduced from user-provided voice or image data.

The server can also analyze the emotional state of the user (such as a handler) by applying emotion recognition models to audio and video data received from a remote terminal or interface device. Software libraries commonly used for this purpose might include Affectiva or open-source emotion detection frameworks for both facial image and vocal analysis. When an emotional state is detected, the server can modify the prompt sentence or adapt the action instructions accordingly, for example, to ensure that guidance delivered to an animal or robot remains optimal under stressful human conditions.

When the action instruction has been generated, the server converts the instruction text into audio output using text-to-speech software (such as open-source TTS libraries or cloud TTS services). The instruction is sent to the respective terminal, which plays the message through its speaker, making it audible to the animal or robot. The terminal then proceeds to execute or behave in accordance with the issued instruction, triggering new data collection that will be transmitted back to the server, thus closing the operational loop. The user is provided with a user interface (running, for example, on a general-purpose display device such as a smartphone, tablet, or computer). Through this interface, the user can monitor live image, audio, and environmental readings, review received instructions, and intervene by sending manual commands when necessary. The user can also observe the current emotional analysis feedback on the interface.

For example, if the terminal captures an image including a human figure, detects the audio “help”, and records a rapid temperature rise, the server may analyze these inputs and generate the following prompt sentence:

“Camera shows a human figure at three meters ahead. Microphone detected the word ‘help’. Temperature is abnormally high. Generate an action instruction for the animal to approach carefully and for the operator to be notified.”

The generative AI model would then output an action instruction, such as:

“Approach the detected person with caution. Notify the operator that the temperature is high in this area and proceed slowly.”

If the emotional analysis of the user recording revealed stress or agitation, the prompt sentence might be adapted as follows:

“Camera shows a human figure at three meters ahead. Microphone detected the word ‘help’. Temperature is abnormally high. The operator appears anxious. Generate an action instruction that reassures the operator and directs the animal to proceed carefully.”

The system thus ensures that situational awareness, adaptive response, and emotional context are seamlessly integrated into the rescue workflow. This embodiment is supported by general-purpose hardware and widely available software libraries, making it both practical and effective for real-world deployment.

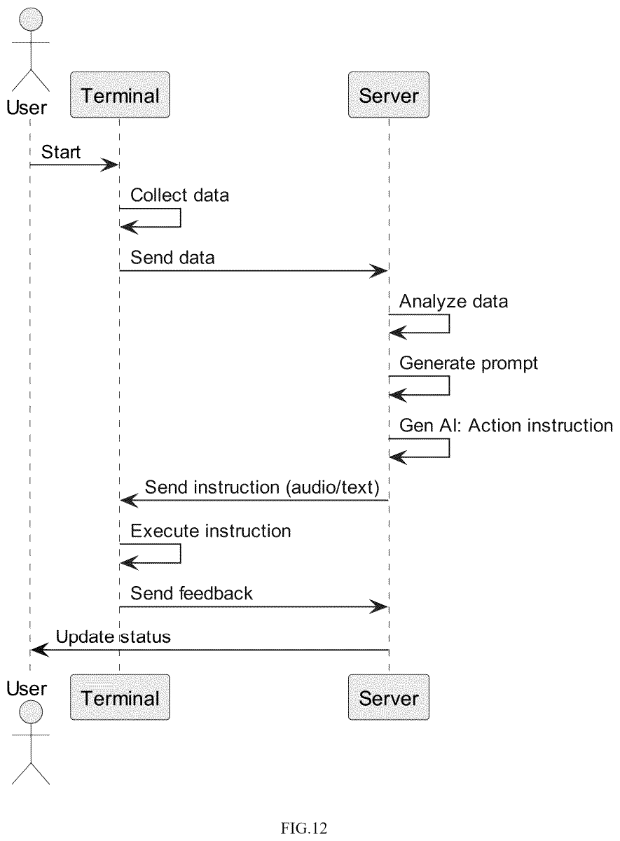

The following describes the processing flow using FIG. 12.

### Step 1:

The terminal activates its camera, microphone, and environmental sensors to collect real-time image data, audio data, and environmental measurements such as temperature, humidity, and acceleration. The input for this step is the current state of the environment around the device. The terminal processes this input by sampling data from each sensor at regular intervals, encoding the data into digital format, assigning timestamps, and temporarily storing the results in local memory. The output of this step is a set of time-stamped sensor data files prepared for transmission.

### Step 2:

The terminal transmits the collected data to the server using a wireless communication module. The input in this step is the set of locally stored sensor data files from Step 1. The terminal processes these files by organizing them into data packets and establishing a secure wireless connection (such as via MQTT protocol over Wi-Fi or a cellular network). The output is the successful transmission of sensor data packets to the server.

### Step 3:

The server receives and stores the incoming sensor data from the terminal. The input is the data packet transmitted by the terminal. The server processes this input by validating the integrity of the files, sorting them by device identifier and timestamp, and storing them in a designated storage structure such as a database or file system. The output is a repository of validated, organized data sets ready for further analysis.

### Step 4:

The server analyzes the image, audio, and environmental data using dedicated processing algorithms. The input for this step is the stored sensor data set. The server processes this input by running image files through an object detection model (such as implemented in OpenCV or TensorFlow), audio files through a speech-to-text engine and keyword extractor, and environmental readings through anomaly detection scripts. The output is a set of structured analysis results indicating features such as detected objects, identified keywords, and sensor anomalies.

### Step 5:

The server generates a prompt sentence based on the analysis results and forms an input for the generative AI model. The input is the structured results from Step 4. The server processes the analysis by summarizing findings into a comprehensive, context-aware prompt sentence. For example, the prompt may state: “Image shows a person in front, audio contains the word ‘help’, temperature exceeds 45° C. Generate an action instruction.” The output is a refined prompt sentence for the generative AI model.

### Step 6:

The server inputs the prompt sentence into the generative AI model, which then produces a context-specific action instruction. The input is the prompt sentence composed in Step 5. The server invokes the generative AI model and processes the input to generate a new instruction, such as: “Move forward with caution and alert the operator.” The output is the generated action instruction in text form.

### Step 7:

The server converts the action instruction into audio data and sends it back to the terminal. The input is the action instruction text from Step 6. The server processes this by running text-to-speech software to create an audio file and transmits both the audio and text to the terminal over the wireless connection. The output is the delivery of an actionable instruction in both text and audio format to the terminal.

### Step 8:

The terminal receives the action instruction, plays the audio via its speaker, and adjusts its behavior or notifies the animal accordingly. The input in this step is the audio and text instruction received from the server. The terminal processes these instructions by initiating corresponding behaviors (such as activating a movement control routine, or a flashing LED), and plays the audio message for the animal or user to hear. The output is the execution of the instructed action and guidance for the animal or robot.

### Step 9:

The terminal resumes data collection to monitor the result of the executed action and prepares feedback for the server. The input is the new environmental, image, and audio data acquired after the action instruction has been executed. The terminal processes this information in the same manner as Step 1, but tags it as post-action feedback. The output is a new set of sensor data indicating the effects and results of the instruction.

### Step 10:

The server analyzes the feedback data and, if necessary, repeats the instruction cycle, further refining actions based on ongoing analysis and, optionally, the user's emotional state. The input is the post-action data and any user-provided audio or video for emotional analysis. The server processes this information by combining environmental, situational, and emotional context, adapting subsequent prompt sentences and instructions to optimize the rescue mission. The output is a dynamically updated rescue operation, increasingly tailored to both environmental conditions and operator emotions.

### Step 11:

The user accesses the real-time monitoring interface to review live sensor data, view analysis results, and, if necessary, remotely input manual instructions or commands. The input is live or recent data, instructions, and interface controls accessible to the user. The user acts on this data by assessing rescue progress and issuing manual instructions via the interface, such as “Pause” or “Move to area B”. The output is the submission of user commands into the system, which are then processed and relayed to the terminal by the server.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In disaster relief activities utilizing search and rescue animals, there remain significant challenges in efficiently and promptly collecting and analyzing environmental and situational data, issuing appropriate instructions to the animal under harsh conditions, and continuously monitoring the status of both the rescue animal and the handler, including the handler's emotional state. Additionally, conventional systems often lack the capability for real-time integration of multimodal sensor data, remote operator intervention, and adaptive instruction generation that accounts for changing environmental and user emotional factors in a robust manner.

The specific processing by the specific processing unit 290 of the data processing device 12 in Example 2 is realized by the following means.

The present invention provides a server comprising a processor configured to receive and analyze, in real time, multimodal sensor data including visual, audio, and environmental information from a waterproof wearable terminal attached to an animal, to synthesize and deliver action instructions through an audio output device, to assess the state of a remote operator based on audio and image data for emotional estimation, and to provide a remote interface for real-time monitoring and instruction input by the operator. This enables the system to support robust, adaptive, and efficient control and assistance for rescue animals in disaster settings, ensuring accurate instruction delivery under adverse conditions and enhancing handler involvement through emotional state-aware operations.

The term “processor” refers to an information processing device configured to execute instructions, carry out data analysis, and control system operations based on received input data.

The term “wireless communication unit” refers to a hardware and/or software component that enables data transfer between devices without the use of physical cables, utilizing wireless protocols such as Wi-Fi or Bluetooth.

The term “imaging device” refers to an apparatus, such as a camera, capable of capturing visual data from the surrounding environment.

The term “audio acquisition device” refers to a device, such as a microphone, that captures audio signals from the environment.

The term “external environment detection device” refers to a sensor or a set of sensors that measure environmental conditions, including but not limited to temperature, humidity, and motion.

The term “waterproof wearable information processing terminal” refers to a compact computing unit, protected against ingress of water, designed to be attached or mounted to a biological body for continuous data acquisition and wireless communication.

The term “biological body” refers to a living animal or human to which the wearable information processing terminal is attached in order to collect data and deliver instructions.

The term “action instruction audio information” refers to synthesized voice data or sound signals generated by the system to convey operational commands to the biological body.

The term “audio output device” refers to a means, such as a speaker, that plays back audio signals including instructions generated by the processor.

The term “user state” refers to the physical or emotional status of the operator or handler, determined by analyzing patterns in audio and image data.

The term “emotional state” refers to the affective condition, such as stress, calmness, or excitement, of the user, as estimated by processing the user's audio and visual data.

The term “communication terminal” refers to an external device, such as a smartphone or tablet, through which the operator can view system data and input commands.

The term “information presentation and input interface” refers to a graphical user interface provided on the communication terminal that enables the operator to monitor information related to the biological body and enter new commands.

The term “operator” refers to a human user who interacts with the system to monitor, control, and instruct the biological body remotely.

The term “instruction history” refers to a log of previously issued operational commands and the relevant timestamps or conditions under which they were provided.

The term “behavioral results” refers to the observed actions or responses of the biological body as recorded and analyzed by the system.

The term “environmental changes” refers to variations in the physical surroundings of the biological body, as detected by the external environment detection device.

The term “object detection” refers to the computational process of identifying and locating specific objects within visual data acquired from the imaging device.

The term “characteristic sound recognition” refers to the process by which unique or notable audio features, such as human distress calls, are detected and classified from audio data.

A preferred embodiment of the invention will now be described in detail, based on the scope of the claims. The invention provides a system for supporting the efficient and adaptive operation of a rescue animal during a disaster situation, enabling real-time data collection, analysis, and behavioral instruction in a robust and user-adaptive manner.

The terminal comprises an imaging device, an audio acquisition device, and an external environment detection device, all integrated into a waterproof wearable information processing terminal. The terminal is configured to be attached to the collar or harness of a biological body, such as a rescue animal. The imaging device may include a miniature digital camera; the audio acquisition device may be a sensitive microphone; and the external environment detection device may consist of sensors such as temperature sensors, humidity sensors, and accelerometers. The terminal is equipped with a wireless communication unit, such as a Wi-Fi or Bluetooth module, enabling data transmission to and from the processor.

The processor, typically residing on a server, is configured to receive multimodal data from the terminal in real time. The server processes visual data using software frameworks such as TensorFlow and OpenCV, and processes audio data using speech recognition libraries. The server may also employ dedicated algorithms for sensor fusion to correlate movement, environmental, and visual/auditory cues. For speech synthesis, text-to-speech software such as a general-purpose text-to-speech engine may be used to generate audio instructions.

The server analyzes the received data to detect specific objects or persons, recognize notable sounds, and assess the environment's safety or danger. In addition, the server is capable of analyzing the state of a remote operator (user) by processing audio and video data acquired via a communication terminal, such as a smartphone or tablet, which is used by the operator to interface with the system. Emotion recognition algorithms are employed to estimate the operator's emotional state.

The server generates behavior instructions for the biological body based on the analysis of environmental data, sensor signals, and the emotional state of the user. These instructions are then converted into synthesized speech and transmitted wirelessly to the terminal. The terminal includes an audio output device, such as a speaker, which delivers the instruction as a sound to the animal.

The user can monitor the real-time status, activity history, and environmental information through an information presentation and input interface provided on the communication terminal. The user is thus able to send additional behavior instructions or modifications at any time. All behavior instructions and feedback are logged by the server for monitoring and analysis.

For manufacturing, the wearable terminal components can be designed using weather-resistant materials, ensuring the reliable operation of the system under harsh conditions. The integration of the camera, microphone, sensors, and wireless unit should be optimized for low power consumption, reliability, and comfort for the animal.

As a concrete example, during a disaster search scenario, the terminal records and transmits visual, audio, and sensor data. The server analyzes this information, identifies a person in need, and generates a verbal instruction, “Move closer,” which is sent as audio to the animal. If the user is detected to be anxious, the server may also generate a calming instruction such as “Proceed slowly.” The user can view the dog's perspective and provide manual input, such as “Stop and scan the area,” through the interface.

### Example Generative AI Model Prompt:

Please describe, in sequence and with technical details, a multi-component disaster rescue system utilizing a smart collar (with camera, microphone, sensors), a central data analysis server (using deep learning frameworks and speech synthesis), an emotion-recognition engine for the human operator, and a user interface for control and monitoring. Focus on the data flow and processing at each step, and use ‘server,’ ‘terminal,’ and ‘user’ as the main subjects.

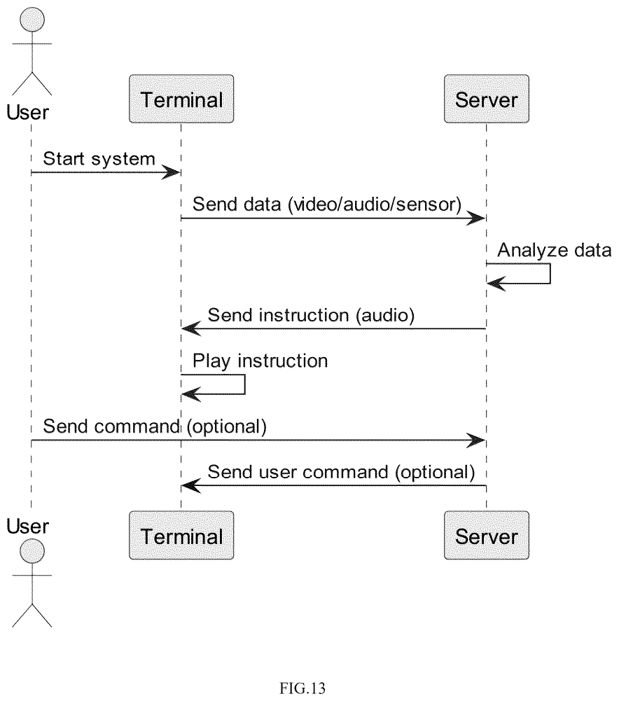

The following describes the processing flow using FIG. 13.

### Step 1:

Terminal activates the imaging device, audio acquisition device, and external environment detection devices (such as temperature, humidity, and acceleration sensors) mounted on the animal's collar. Terminal collects visual data, audio data, and sensor data at periodic intervals.

Input: Environmental conditions and animal activity observed by the camera, microphone, and sensors.

Operation: Terminal converts analog signals from the camera, microphone, and sensors into digital data streams, timestamps them, and prepares the data packets.

Output: Digitized, timestamped packets of video, audio, and sensor data.

### Step 2:

Terminal establishes a wireless connection (using Wi-Fi or Bluetooth) to the server and transmits the data packets in real time.

Input: Digitized, timestamped packets produced in Step 1.

Operation: Terminal sends data packets over the wireless module, monitors the connection status, and automatically retries if any packet is lost.

Output: Data packets successfully delivered to the server.

### Step 3:

Server receives the incoming data packets and separates video, audio, and sensor streams for analysis.

Input: Data packets sent from the terminal.

Operation: Server parses incoming data, buffers it for stability, and checks data integrity and synchronization.

Output: Separated streams of visual, audio, and sensor data available for further processing.

### Step 4:

Server analyzes visual data using image processing software (such as a general-purpose deep learning framework) to detect objects, people, or obstacles in the dog's environment.

Input: Visual data stream.

Operation: Server applies object detection algorithms to each frame of the video, tags recognized features, and notes their positions relative to the animal.

Output: List of detected objects, persons, or environmental features with associated metadata.

### Step 5:

Server analyzes audio data to detect notable sounds, such as human distress calls or relevant environmental noise.

Input: Audio data stream.

Operation: Server performs voice activity detection, applies speech and audio classification algorithms, and identifies keywords or specific sound patterns.

Output: Detected sound events and their classifications.

### Step 6:

Server analyzes sensor data to assess the animal's motion, orientation, and environmental status (such as movement, temperature, or humidity changes).

Input: Sensor data stream.

Operation: Server compares sensor readings to predefined thresholds, detects anomalies, and determines if the environment is hazardous or if the animal is moving as expected.

Output: Analysis report on animal behavior and environmental safety status.

### Step 7:

Server integrates results from visual, audio, and sensor analysis to form a comprehensive understanding of the scene and urgency.

Input: Outputs from Steps 4, 5, and 6.

Operation: Server uses sensor fusion algorithms to combine the analysis results, assigns an urgency or priority score to the situation, and determines the proper course of action.

Output: Situation assessment report with action recommendations.

### Step 8:

Server generates behavior instructions for the animal based on situation assessment, and converts these into speech audio using text-to-speech software.

Input: Situation assessment report.

Operation: Server selects or creates appropriate instructions (such as “move closer” or “stay still”), synthesizes them into clear audio files.

Output: Synthesized audio instruction data.

### Step 9:

Server transmits the audio instruction data back to the terminal via the wireless network.

Input: Synthesized audio instruction data.

Operation: Server sends the audio file to the terminal for immediate playback and records the transmission for logging.

Output: Audio instruction data available at the terminal.

### Step 10:

Terminal receives the audio instruction data and plays it through the built-in speaker to deliver vocal commands to the animal.

Input: Audio instruction data from the server.

Operation: Terminal activates the speaker, plays the instruction at an appropriate volume, and verifies playback success.

Output: Animal receives and responds to the spoken instruction.

### Step 11:

Server simultaneously collects video and audio of the user (operator) via a user interface (smartphone or tablet), analyzes the operator's emotional state using emotion recognition algorithms.

Input: Live video and audio of the operator from the user terminal.

Operation: Server extracts features from the operator's speech tone, facial expressions, and other cues, performing analysis to estimate emotional state (such as stress or calmness).

Output: Detected operator emotional state.

### Step 12:

Server adapts further animal instructions or sends supportive feedback to the operator depending on the emotional state detected.

Input: Operator emotional state, situation assessment report.

Operation: Server generates supplemental commands (e.g., “proceed slowly” if stress is high) or supportive messages for the operator interface.

Output: Supplemental instruction for the animal or feedback/advice for the user interface.

### Step 13:

User monitors live video, sensor status, and command history through the information interface on the terminal device and may enter additional commands or instructions as needed.

Input: Real-time status, sensory feedback, interface controls.

Operation: User reviews system outputs, enters manual instructions (such as “pause for safety check”) using the touch interface, and sends these commands to the server for execution.

Output: Manual override or supplemental instruction transmitted to the server for processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional systems for supporting disaster rescue animals or security operations often do not adequately considers the emotional state of human operators, such as handlers or security personnel, and are limited to generating action instructions based solely on simple analysis of collected data. This limitation can result in delayed or inappropriate responses in high-stress or emergency situations, as real-time monitoring and emotional context are not sufficiently integrated into the control or support system. Furthermore, the feedback cycle for processing environmental changes, emotional nuance, and immediate action requirements is inefficient, thereby impeding effective support and quick response during dynamic operations.

The specific processing by the specific processing unit 290 of the data processing device 12 in Application Example 2 is realized by the following means.

The present invention provides a server comprising a processor configured to receive real-time image, audio, and environmental data from a terminal device, perform real-time analysis using an artificial intelligence platform to detect context including suspicious objects and emotional states of operators, generate action instruction data based on these analyses, convert the data into audio signals, and transmit these instructions back to the terminal to be output through a speaker. This enables timely, context-aware, and emotionally adaptive instruction to the animal or personnel, closing the feedback loop for rapid and appropriate responses in disaster rescue and security settings.

The term “processor” refers to a hardware computing unit or a set of hardware computing units capable of executing programmed instructions, performing data processing, and managing communication and control functions within the system.

The term “terminal device” refers to a hardware apparatus equipped with at least an image capture unit, an audio acquisition unit, a physical quantity detection unit, and a wireless communication module, and is configured to collect, process, and transmit data from its operational environment.

The term “image information” refers to video data or still image data captured by an image capture unit, such as a camera, and used for analysis of visual conditions in a monitored area.

The term “audio information” refers to sound data or voice data captured by an audio acquisition unit, such as a microphone, and includes environmental sounds and speech used for analysis.

The term “environmental information” refers to physical measurement data acquired by physical quantity detection units, including but not limited to temperature, humidity, acceleration, and other sensor outputs representing the surrounding environment of the terminal device.

The term “central processing unit” refers to a computing node or cluster capable of receiving and analyzing data from multiple terminal devices, executing artificial intelligence-based data analytics, and coordinating feedback control over the system.

The term “artificial intelligence processing platform” refers to a software and/or hardware framework equipped to execute learning-based and inference-based algorithms, such as image recognition and emotion detection, in real time.

The term “action instruction data” refers to information generated as a result of analysis, representing commands, warnings, or guidance in response to detected events or operator states, and is intended for subsequent communication to relevant parties or devices.

The term “audio signal” refers to a digital or analog waveform derived from textual action instruction data, suitable for playback as speech or other auditory cues through a speaker.

The term “speaker” refers to an audio output device capable of converting electrical audio signals into audible sound waves for communication to human or animal recipients. The term “object recognition function” refers to a software mechanism, typically based on artificial intelligence, configured to identify and classify objects or persons within image information using pattern recognition or machine learning technologies.

The term “operator” refers to a person responsible for managing, monitoring, or controlling the system and may include remote handlers, security personnel, or other relevant human actors.

The term “emotional state” refers to the psychological or affective status of a person, such as tension, anxiety, or calmness, inferred from audio and/or visual cues analyzed by the system.

An embodiment for implementing the invention will be described below. The system comprises a terminal device, such as a wearable collar-type or mobile robot unit, equipped with at least a camera unit, an audio acquisition unit, and a plurality of environmental sensors, each housed within an enclosure possessing waterproof characteristics. The terminal device further includes a wireless communication module, such as a Wi-Fi or LTE modem, and an audio output device such as a loudspeaker.

The terminal device continuously collects image information through the camera unit, audio information via the microphone, and environmental information including temperature, humidity, and acceleration from the sensors. These raw data are formatted appropriately, for example as MP4 for images and video, WAV for audio, and JSON for sensor measurements.

The terminal device then transmits the collected data in real time to the server (central processing unit) using wireless communication technology. The server may be implemented on a dedicated physical computer, edge computing system, or cloud-based infrastructure.

The server is configured with a processor running an artificial intelligence processing platform. Specific implementations for this platform may include open source or commercially available software such as:
For image recognition: OpenCV and a deep learning object detection framework such as YOLO (You Only Look Once)
For speech-to-text transformation and audio analysis: speech recognition libraries or services such as a cloud-based speech-to-text API
For emotion analysis: an emotion recognition module such as a tone analyzer leveraging machine learning models designed for sentiment or psychological state inference
For text-to-speech conversion: a text-to-speech (TTS) engine, which may be implemented by any commercially available software or open source solution

The server receives video, audio, and environmental information from the terminal device. The server analyzes the real-time video data using the object recognition framework, detects suspicious objects or persons, and annotates this information with confidence levels and locations. The server also converts the audio data into text using a speech-to-text engine and analyzes both the voice and the transcribed content for stress, anxiety, or other emotional states by leveraging the emotion analysis module.

Based on the outcome of these analyses, the server generates action instruction data, for example, an instruction to warn or notify a detected person, or to advise the operator or animal on an appropriate response. The server then converts this textual command into an audio signal using the TTS engine.

The server transmits this audio signal to the terminal device, which then outputs the instruction via the speaker. The instructions may be addressed to either a human operator, a third party, or the animal equipped with the system.

The user, serving as an operator such as a handler or security staff member, may also remotely access the central processing unit/server through a dedicated interface for monitoring the situation, reviewing logs, modifying conditions for action instruction generation, or issuing manual instructions in real time.

As a concrete example, consider a scenario in which a mobile robot equipped as a terminal device is patrolling a facility. The camera captures an image of a person entering a restricted area. The microphone records audio, including the person's speech and environmental sounds. The sensors detect abnormal movement.

The server, upon receiving the video, detects and classifies the person as a suspicious target. The audio is analyzed to detect any distress or emergency keywords. If the emotional state of the operator is assessed as anxious, the server generates two instruction messages: one warning for the detected person, and one advisory for the operator. These are transmitted as audio signals and played through the respective speakers of the terminal device.

An example of a prompt sentence suitable for input into a generative AI model in this context is as follows:

“Analyze this surveillance camera footage to determine if there is a suspicious person present. If a suspicious person is detected, generate the audio message: ‘There is a suspicious person. Please leave immediately.’ Additionally, analyze the audio for signs of stress in the security officer's voice and, if detected, generate an encouraging message: ‘Please stay calm. Help is on the way.’”

This embodiment enables flexible, adaptive, and context-aware generation and delivery of audio instructions, thereby supporting both machine-based and human-based interception, intervention, and feedback in dynamic or emergency environments. It also allows for the emotional state of human users to be incorporated into the instruction generation process, enhancing the operational effectiveness of the system in real-world scenarios.

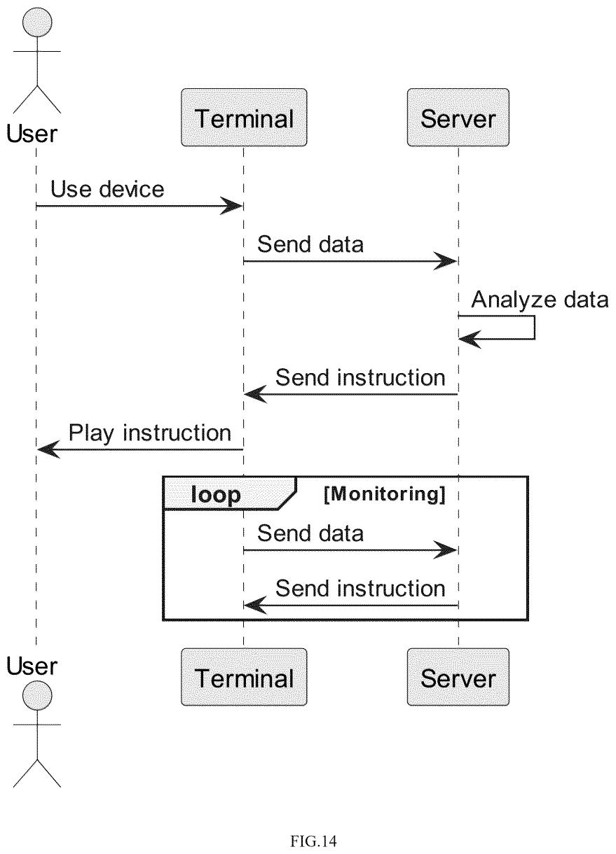

The following describes the processing flow using FIG. 14.

### Step 1:

The terminal activates a camera, a microphone, and multiple sensors (such as temperature, humidity, and acceleration sensors). The terminal collects real-time image data, audio data, and environmental data by capturing video, recording ambient sounds and verbal communications, and measuring physical parameters at set intervals.

Input: Environmental conditions in the physical world.

Output: Raw image files (e.g., MP4), raw audio files (e.g., WAV), and sensor reading files (e.g., JSON).

### Step 2:

The terminal formats and packages the collected image, audio, and sensor data. The terminal establishes a secure wireless connection (e.g., Wi-Fi or LTE) and transmits this data—either as continuous streams or in regular data packets—to the server's designated address.

Input: Raw image, audio, and sensor data.

Output: Data packets containing formatted video, audio, and environmental sensor data.

### Step 3:

The server receives the incoming data packets from the terminal. The server stores the data in a temporal database and verifies its integrity and time synchronization.

Input: Data packets from the terminal (including video, audio, and sensor data).

Output: Synchronized and validated data sets for further processing.

### Step 4:

The server runs an image analysis routine using an artificial intelligence processing platform (e.g., using an image recognition library and an object detection model). The server processes video frames to detect and classify objects or persons of interest, such as intruders or abnormal situations.

Input: Synchronized image data.

Operation: The server applies a machine learning model for object detection and annotation.

Output: Detected object and person classifications, with corresponding confidence scores and location coordinates.

### Step 5:

The server processes audio data to identify speech content and environmental sounds. The server uses a speech-to-text engine to create a transcript of any spoken words, and applies pattern recognition to detect alarm sounds or keywords.

Input: Synchronized audio data.

Operation: The server converts audio to text and detects specific patterns or phrases using natural language processing.

Output: Detected keywords, phrases, unusual sounds, and full text transcripts.

### Step 6:

The server runs an emotion analysis on the user's speech (‘user’ refers to the human operator or handler). The server extracts voice features from the audio, analyzes the text and tonal inflections using a sentiment/emotion analysis model, and infers the operator's emotional state.

Input: User's audio data and speech transcript.

Operation: The server uses an emotion detection model to classify emotional state (e.g., calm, stressed).

Output: Emotional state score and classification.

### Step 7:

The server integrates the results of the image analysis, audio analysis, and emotion analysis to generate appropriate action instruction data. The server selects contextually relevant instructions, such as warning messages for intruders or advice for operators under stress.

Input: Object/person detections, sound/keyword detections, and emotional state results.

Operation: The server applies logic rules or a generative AI model to determine suitable actions and prepares the instruction as text data.

Output: Textual action instruction data.

### Step 8:

The server converts the action instruction data into audio signals using a text-to-speech (TTS) engine, generating a digital audio file corresponding to the action to be communicated.

Input: Textual action instruction data.

Operation: The server sends the text to the TTS module, which synthesizes spoken instructions in the desired language and voice.

Output: Audio file carrying synthesized speech.

### Step 9:

The server transmits the generated audio files to the terminal via a wireless connection, specifying the playback target (e.g., public warning or operator-only advice).

Input: Audio file(s) for instruction.

Output: Transmission of audio file(s) to the terminal.

### Step 10:

The terminal receives the audio file and plays the received instructions through its speaker (for public directions) or internal earpiece (for operator guidance). The terminal also continues to monitor the environment and repeats the data acquisition and transmission cycle.

Input: Audio file(s) from the server, real-time environmental conditions.

Operation: The terminal plays the instruction to the relevant recipient, then restarts the monitoring and reporting process.

Output: Audible instructions delivered to recipients and new raw environmental data for the next processing cycle.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

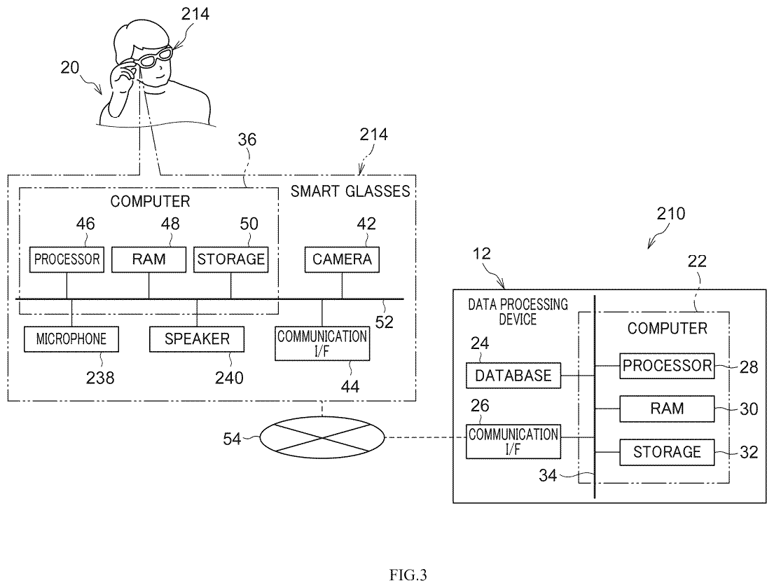

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

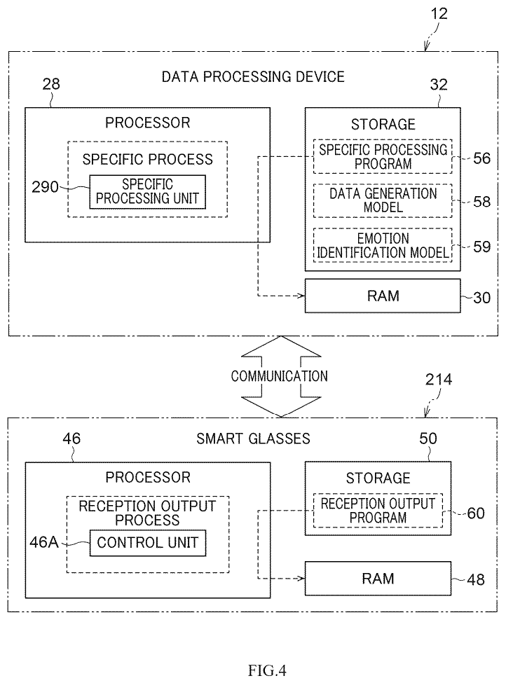

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

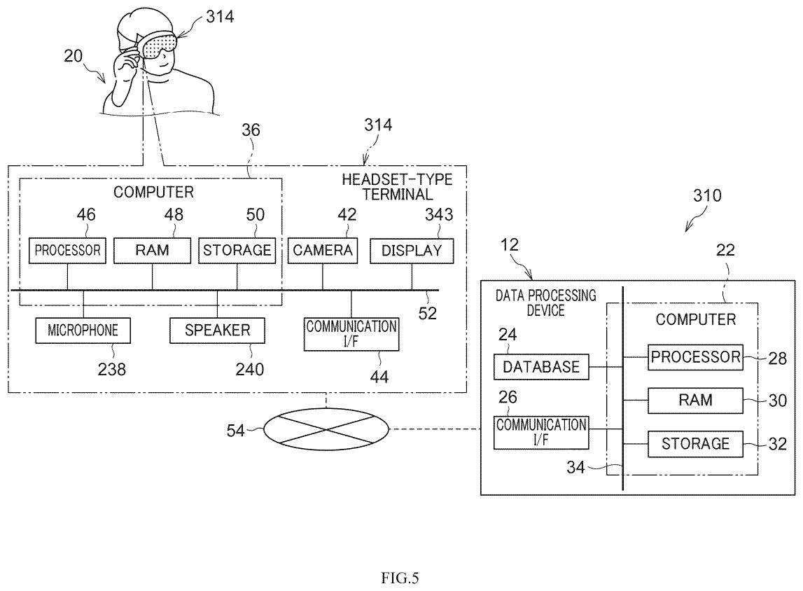

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

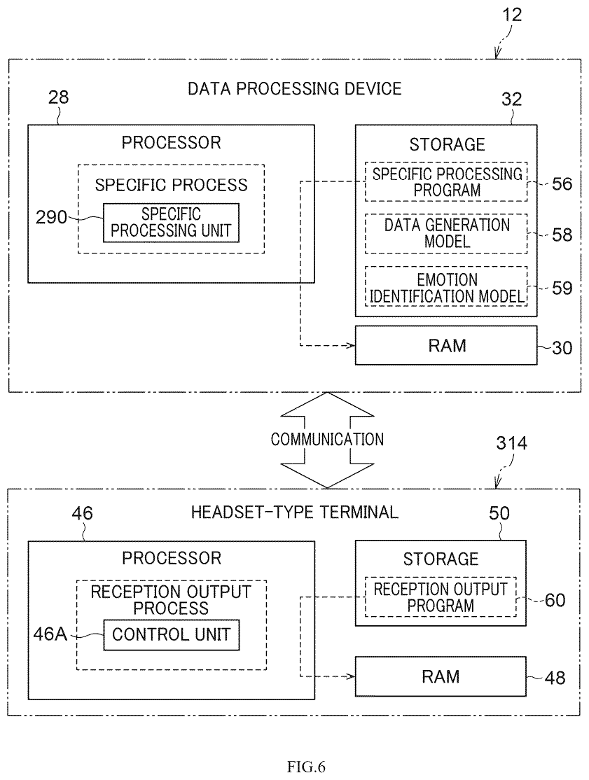

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

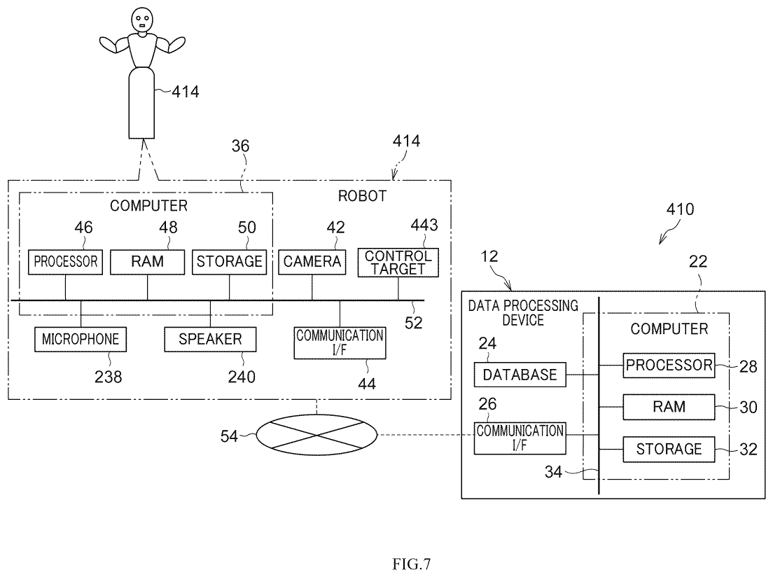

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

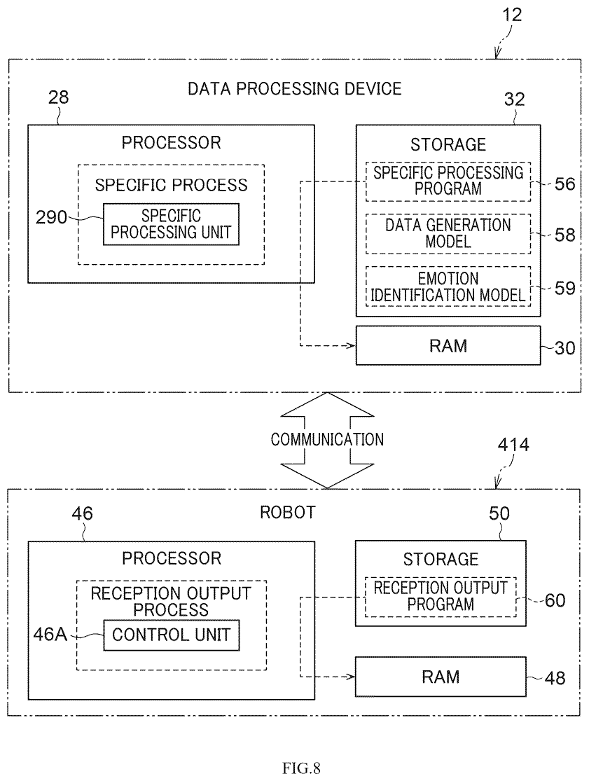

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

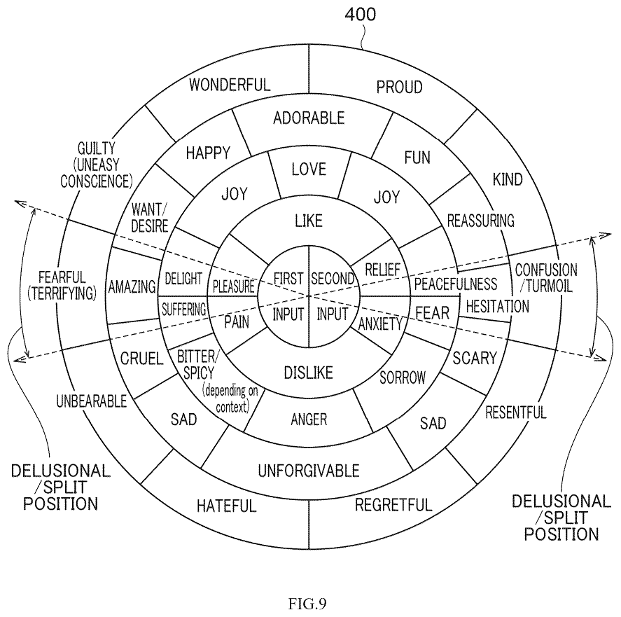

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

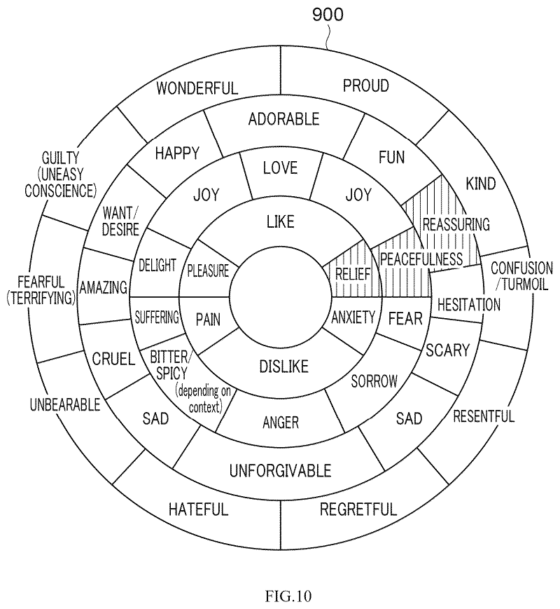

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive video information, audio information, and environmental information transmitted wirelessly from an information collection device having an imaging device, an audio input device, and an environmental information detection device that is incorporated in a waterproof structure and mounted on an animal-retaining apparatus;
analyze the received video information and audio information by using an image recognition processing unit and an audio recognition processing unit;
generate behavior command data based on analysis results and feedback information by using an artificial intelligence model including a generative method;
convert the generated behavior command data into audio data by using a speech conversion processing unit;
output the converted audio data by means of an audio output device; and
display obtained information or analysis results on a remote operation terminal, receive operation input corresponding to user instruction, and transmit input information for the artificial intelligence model to the processor as behavior command data.

### (Supplementary 2)

The system according to supplementary 1,
wherein the processor is configured to generate, based on user operation input received at the remote operation terminal, behavior command data as input information for the artificial intelligence model and to transmit said data to the processor.

### (Supplementary 3)

The system according to supplementary 1,
wherein the processor is configured to detect, by means of the image recognition processing unit, a specific object from the acquired video information, to recognize a specific audio pattern from the audio information by means of the audio recognition processing unit, and to input a prompt sentence including these items into the artificial intelligence model so as to generate the behavior command data.

### Application Example 1

### (Supplementary 1)

A system comprising a processor,
wherein the processor is configured to
acquire image information, audio information, and environmental information from an information acquisition unit mounted on an animal,
transmit the acquired image information, audio information, and environmental information to an external device using wireless communication,
analyze the received information with an image processing function, an audio processing function, and an environmental data processing function,
automatically generate a prompt sentence based on the analysis results and input the prompt sentence to a generative artificial intelligence model,
generate an action instruction using the generative artificial intelligence model, output the generated action instruction as audio information to a terminal,
execute an action by the terminal based on the audio information, and
perform a feedback process in which post-action information is reacquired and processed.

### (Supplementary 2)

The system according to supplementary 1,
wherein the processor is configured to
allow a user to confirm in real time, via a terminal or a display device, the acquired image information, audio information, environmental information, and action instruction information, and to input remote operation instructions to the processor or to the terminal.

### (Supplementary 3)

The system according to supplementary 1,
wherein the processor is configured to
analyze the emotional state of the user based on the user's audio information and image information, and adaptively change the prompt sentence for the generative artificial intelligence model and the action instruction according to the analyzed emotional state.

### Example 2

### (Supplementary 1)

A system comprising a processor,
wherein the processor is configured to
receive, via a wireless communication unit, information collected from an imaging device, an audio acquisition device, and an external environment detection device, the imaging device, audio acquisition device, and external environment detection device being integrated in a waterproof wearable information processing terminal attached to a biological body;
analyze the received information in real time to generate action instruction audio information and process synthesized sound;
transmit the generated action instruction audio information to an audio output device via the wearable information processing terminal, in order to deliver behavioral instructions to the biological body;
analyze user state based on audio information and image information to estimate emotional state;
provide, through a communication terminal, an information presentation and input interface enabling an operator to acquire and view status and activity history of the biological body and transmit additional instructions; and
monitor, based on collected information and instruction history, behavioral results and environmental changes of the biological body.

### (Supplementary 2)

The system according to supplementary 1,
wherein the processor is configured to
permit the operator at a remote location to sequentially confirm on a communication terminal the on-site images, environmental information, and behavioral history of the biological body, and to input new behavioral instructions via the information presentation and input interface.

### (Supplementary 3)

The system according to supplementary 1,
wherein the processor is configured to
analyze, in an integrated manner, the image information from the imaging device and the audio information from the audio acquisition device, perform object detection and characteristic sound recognition in parallel, and generate behavioral instruction information according to external factors and user state.

### Application Example 2

### (Supplementary 1)

A system comprising a processor,
wherein the processor is configured to
   receive image information, audio information, and environmental information collected in real time by a terminal device having an integrated camera unit, audio acquisition unit, and physical quantity detection unit with waterproof characteristics,
transmit the collected image information, audio information, and environmental information via wireless communication from the terminal device to a central processing unit, analyze, in real time, the image information, audio information, and environmental information using an artificial intelligence processing platform, and generate action instruction data based on an analysis result,
convert the action instruction data from text format to an audio signal, transmit the audio signal to the terminal device,
cause the terminal device to output the audio signal through a speaker to provide an action instruction to an animal or person,
analyze the audio information and image information to determine an emotional state of a person, and
generate additional action instruction data based on the analysis of the emotional state.

### (Supplementary 2)

The system according to supplementary 1,
wherein the processor is configured to
enable an operator at a remote location to access the central processing unit, monitor the information, and control the generation or transmission of the action instruction data as needed.

### (Supplementary 3)

The system according to supplementary 1,
wherein the processor is configured to
detect a specific object or person from the image information using an object recognition function of the artificial intelligence processing platform.

What is claimed is:

1. A system comprising a processor,
wherein the processor is configured to:
control a waterproof device equipped with a camera, a microphone, and various sensors, said device being attachable to a collar;
analyze in real time information collected from the camera and the microphone by means of an AI infrastructure implemented on a server; and
transmit instructions generated by the server to a speaker for communicating the instructions to a rescue dog.

2. The system according to claim 1,
wherein the processor is configured to enable a handler in a remote location to check information in real time and to issue instructions.

3. The system according to claim 1,
wherein the processor is configured to analyze images captured by the camera and detects specific objects by object recognition using the AI infrastructure.
